(19) United States
(12) Patent Application Publication
(10) Pub. No.: US 2025/0272966 A1
(43) Pub. Date: Aug. 28, 2025

(54) TECHNIQUES FOR INTERPRETABLE CLASSIFICATION VIA MULTI-LEVEL CONCEPT PROTOTYPES

(71) Applicant: NVIDIA CORPORATION, Santa Clara, CA (US)

(72) Inventor: Chien-Yi WANG, New Taipei City (TW)

(21) Appl. No.: 18/882,563

(22) Filed: Sep. 11, 2024

Related U.S. Application Data
(60) Provisional application No. 63/559,145, filed on Feb. 28, 2024.

(51) Int. Cl. G06V 10/82; G06V 10/75

(52) U.S. Cl. CPC G06V 10/82; G06V 10/751

(57) ABSTRACT

One embodiment of a method for classifying data includes processing the data via a trained machine learning model that includes a plurality of layers, where each layer generates one or more corresponding features, generating a first distribution of features based on the one or more corresponding features generated by each layer included in the plurality of layers, and determining a first class for the data based on a comparison of the first distribution of features with one or more predefined distributions of features that are associated with one or more classes.

### CROSS-REFERENCE TO RELATED APPLICATIONS

This application claims benefit of the United States Provisional Patent Application titled “AN INTERPRETABLE CLASSIFIER VIA MULTI-LEVEL CONCEPT PROTOTYPES,” filed Feb. 28, 2024, and having serial number U.S. Ser. No. 63/559,145. The subject matter of this related application is hereby incorporated herein by reference.

### BACKGROUND

### Field of the Various Embodiments

The embodiments of the present disclosure relate generally to the fields of computer science, machine learning and artificial intelligence (AI), and more specifically, to techniques for interpretable classification using multi-level concept prototypes.

### DESCRIPTION OF THE RELATED ART

Machine learning can be used to discover trends, patterns, relationships, and/or other attributes related to large sets of complex, interconnected, and/or multidimensional data. To glean insights from large data sets, artificial neural networks, regression models, support vector machines, decision trees, naïve Bayes classifiers, and/or other types of machine learning models can be trained using input-output pairs in the data. In turn, the trained machine learning models can be used to guide decisions and/or perform tasks related to the data and/or other similar data.

Within machine learning, neural networks can be trained to perform a wide range of tasks with a high degree of accuracy. Neural networks are therefore becoming more widely adopted in the field of artificial intelligence. Neural networks can have a diverse range of network architectures. In more complex scenarios, the network architecture for a neural network can include many different types of layers with an intricate topology of connections among the different layers. For example, some neural networks can have ten or more layers, where each layer can include hundreds or thousands of neurons and can be coupled to one or more other layers via hundreds or thousands of individual connections.

One drawback of conventional machine learning models is that, oftentimes, developers have very little insight into the internal workings of these models. In the case of conventional neural networks, a developer may not understand how the neurons within a given neural network work together to generate an output, even if the developer knows the different layers of neurons within that neural network. Currently, few, if any, effective approaches exist for revealing or explaining how the different layers of a neural network, operating at different levels of abstraction, cause the neural network to generate particular outputs. Due to the lack of insight into the internal workings of conventional neural networks, developers can have difficulty debugging, improving, or otherwise modifying neural networks to generate higher quality outputs or to increase accuracy.

As the foregoing illustrates, what is needed in the art are more effective techniques for understanding machine learning models and neural networks, in particular.

### SUMMARY

One embodiment of the present disclosure sets forth a computer-implemented method for classifying data. The method includes processing the data via a trained machine learning model that includes a plurality of layers, where each layer generates one or more corresponding features. The method further includes generating a first distribution of features based on the one or more corresponding features generated by each layer included in the plurality of layers. In addition, the method includes determining a first class for the data based on a comparison of the first distribution of features with one or more predefined distributions of features that are associated with one or more classes.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that concept prototypes, which are learned for each layer of a classifier neural network, can be used to reveal or explain how the different layers of the classifier neural network process data at different levels of abstraction. In addition, the concept prototypes are learned automatically during training of the classifier neural network, without requiring manual guidance, modification of the classifier neural network architecture, or post-hoc analysis after the classifier neural network is trained. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of various embodiments;

FIG. 2 is a more detailed illustration of the machine learning server of FIG. 1, according to various embodiments;

FIG. 3 is a more detailed illustration of the computing system of FIG. 1, according to various embodiments;

FIG. 4 is a more detailed illustration of the model trainer of FIG. 1, according to various embodiments;

FIG. 5 is a more detailed illustration of the application of FIG. 1, according to various embodiments;

FIG. 6 illustrates exemplar concept prototypes for different layers of an interpretable classifier, according to various embodiments;

FIG. 7 illustrates how exemplar multi-level concept prototypes can be used to explain an erroneous classification, according to various embodiments;

FIG. 8 is a flow diagram of method steps for training an interpretable classifier, according to various embodiments; and

FIG. 9 is a flow diagram of method steps for performing classification using a trained interpretable classifier, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for training and using an interpretable classifier neural network (also referred to herein as an “interpretable classifier”). In some embodiments, a model trainer processes a number of training images using the interpretable classifier. Given such training images, layers of the interpretable classifier output feature maps that the model trainer splits into concept segments. For each of one or more training epochs, the model trainer re-computes a multi-concept prototype (MCP) distribution for each of a number of classes that the interpretable classifier is being trained to classify images as. The model trainer re-computes the MCP distributions by performing a principal component analysis (PCA) technique to extract concept prototypes from the concept segments, described above. Then, the model trainer generates, for each training image, a corresponding MCP distribution using the concept prototypes and the concept segments generated from the training image. The model trainer averages the corresponding MCP distributions generated for the training images associated with each class to generate an MCP distribution for the class. In addition, for each of any number of batches of training images, the model trainer computes a loss that includes (1) a Centered Kernel Alignment (CKA) loss term that disentangles features in different concept segments, and (2) a Class-aware Concept Distribution (CCD) loss term that enhances the differences between MCP distributions for images associated with different classes while minimizing the differences between MCP distributions for images associated with the same class. The model trainer updates parameters of the interpretable classifier using the computed loss.

Once trained, the interpretable classifier can be used to process an image to generate a classification of the image and reveal details about how the interpretable classifier generated the classification. In some embodiments, an application can process the image using the interpretable classifier, and different layers of the interpretable classifier output respective features. The application generates an MCP distribution from the features, and the application compares the generated MCP distribution with MCP distributions of features for a number of classes to determine a most similar class, which the image is classified as.

The techniques for training and using an interpretable classifier have many practical applications. For example, those techniques could be used to reveal or explain how the interpretable classifier determined to classify images as belonging to particular classes, which can aid in debugging, improving, or otherwise modifying the interpretable classifier.

The above examples are not in any way intended to be limiting. As persons skilled in the art will appreciate, as a general matter, the techniques for training and using an interpretable classifier described herein can be implemented in any suitable application.

### System Overview

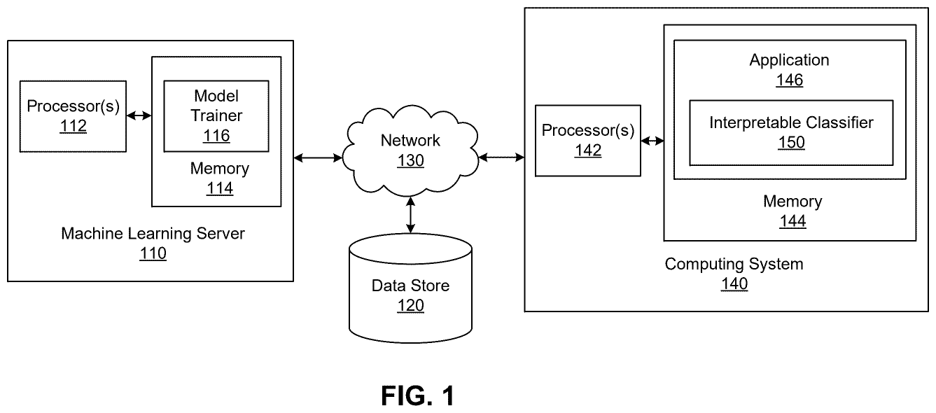

FIG. 1 illustrates a block diagram of a computer-based system 100 configured to implement one or more aspects of various embodiments. As shown, the system 100 includes a machine learning server 110, a data store 120, and a computing system 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the processor(s) 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

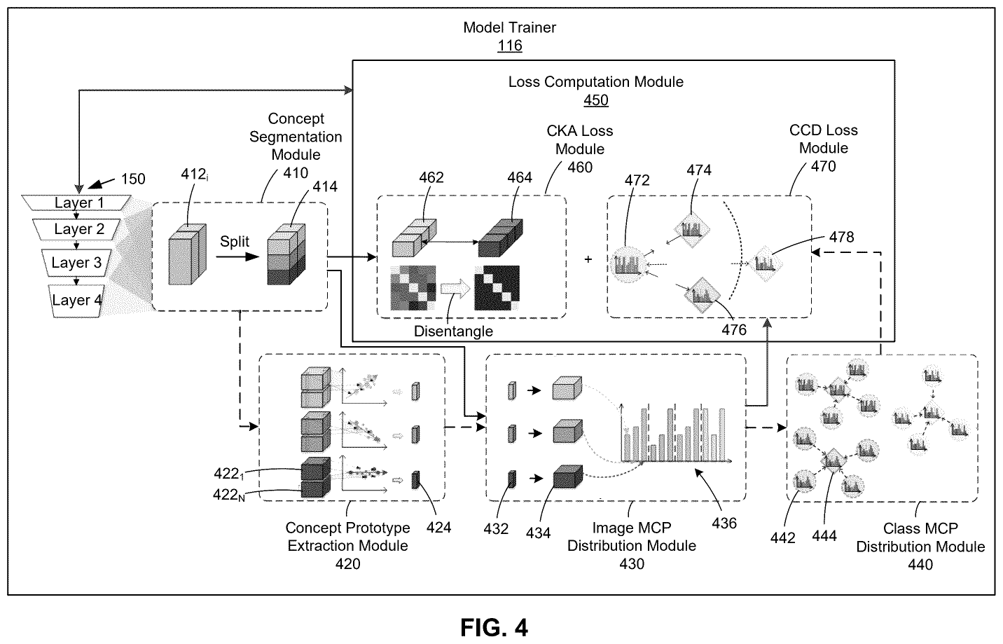

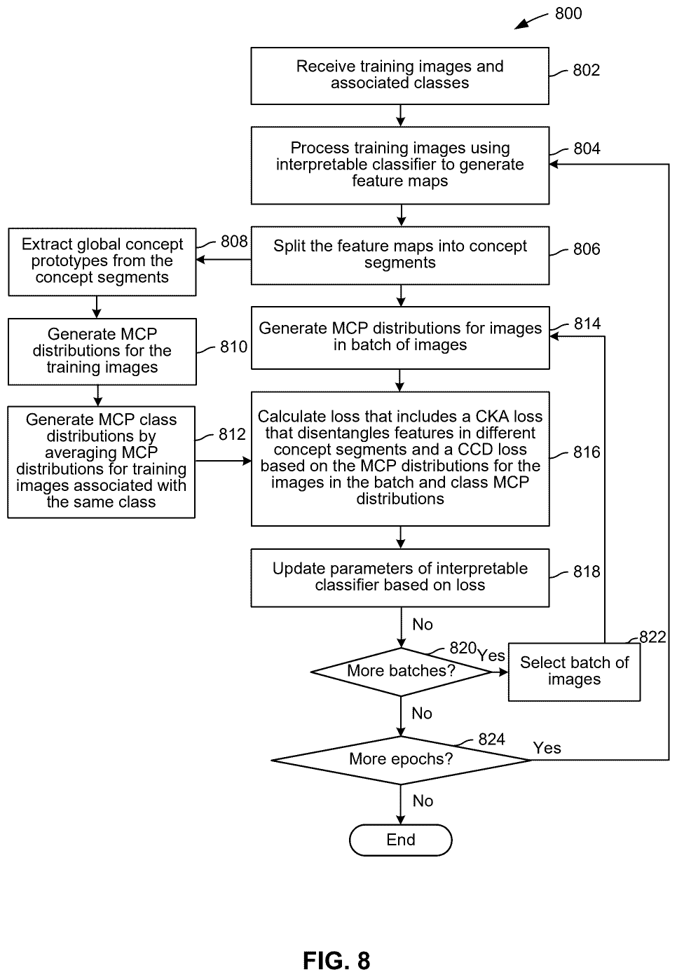

In some embodiments, the model trainer 116 is configured to train an interpretable classifier 150 that can be used to process an image to generate a classification of the image and reveal details about how the interpretable classifier 150 generated the classification. Techniques that the model trainer 116 can employ to train the interpretable classifier 150 are discussed in greater detail below in conjunction with FIGS. 4 and 8. Training data and/or trained (or deployed) machine learning models, including the interpretable classifier 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

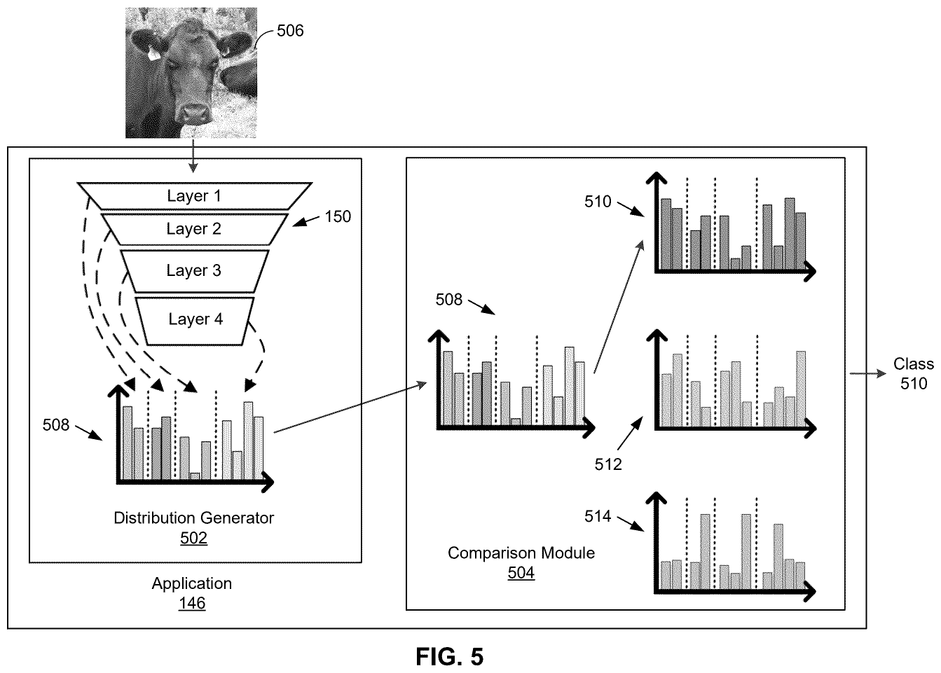

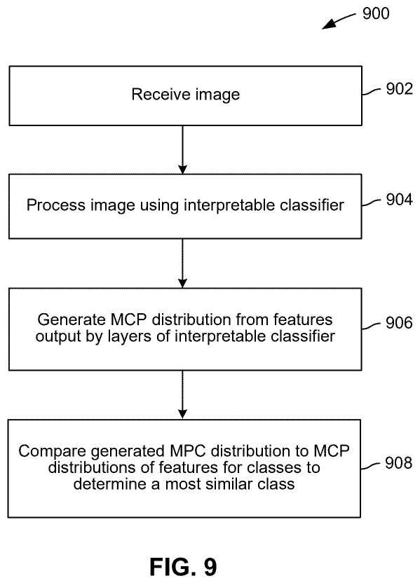

As shown, an application 146 that uses the interpretable classifier 150 is stored in a system memory 144, and executes on a processor 142, of the computing system 140. Once trained, the interpretable classifier 150 can be deployed in any suitable application, such as the application 146. Techniques for performing classification using the interpretable classifier 150 are discussed in greater detail below in conjunction with FIGS. 5 and 9.

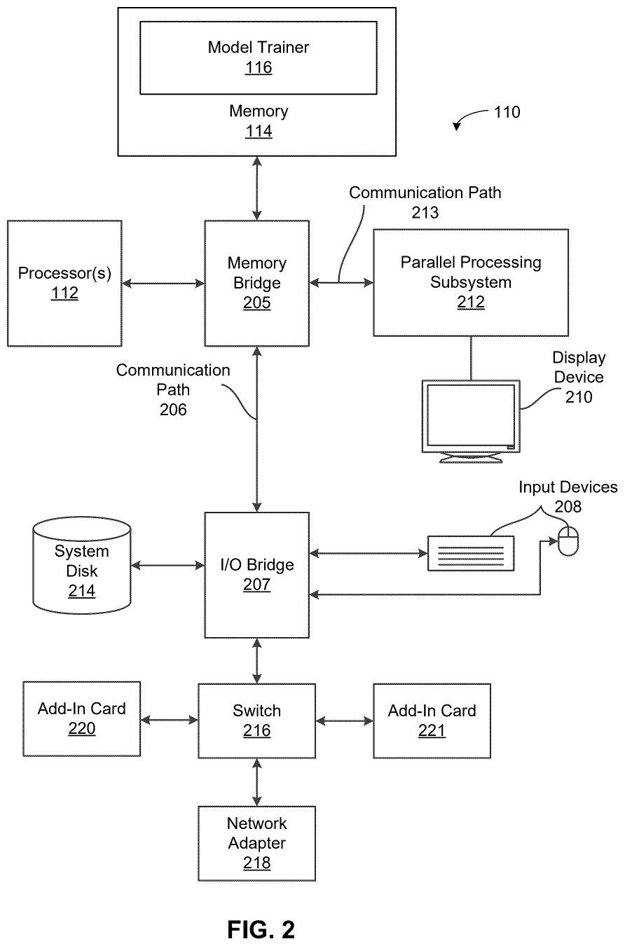

FIG. 2 is a more detailed illustration of the machine learning server 110 of FIG. 1, according to various embodiments. In some embodiments, the machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In some embodiments, the machine learning server 110 includes, without limitation, the processor(s) 112 and the memory (ies) 114 coupled to a parallel processing subsystem 212 via a memory bridge 205 and a communication path 206. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 can be a server machine in a cloud computing environment. In such embodiments, the machine learning server 110 can not include input devices 208, but can receive equivalent input information by receiving commands (e.g., responsive to one or more inputs from a remote computing device) in the form of messages transmitted over a network and received via a network adapter 218. In some embodiments, the switch 216 is configured to provide connections between I/O bridge 207 and other components of the machine learning server 110, such as a network adapter 218 and various add in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, can be implemented using any technically suitable protocols, including, without limitation, AGP (Accelerated Graphics Port), HyperTransport, or any other bus or point to point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations.

The system memory 114 includes at least one device driver configured to manage the processing operations of the one or more PPUs within the parallel processing subsystem 212. In addition, the system memory 114 includes the model trainer 116, discussed in greater detail below in conjunction with FIGS. 4 and 8. Although described herein primarily with respect to the model trainer 116, techniques disclosed herein can also be implemented, either entirely or in part, in other software and/or hardware, such as in the parallel processing subsystem 212.

In some embodiments, the parallel processing subsystem 212 can be integrated with one or more of the other elements of FIG. 2 to form a single system. For example, the parallel processing subsystem 212 can be integrated with the processor(s) 112 and other connection circuitry on a single chip to form a system on a chip (SoC).

In some embodiments, the processor(s) 112 includes the primary processor of the machine learning server 110, controlling and coordinating operations of other system components. In some embodiments, the processor(s) 112 issues commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, can be modified as desired. For example, in some embodiments, the system memory 114 could be connected to the processor(s) 112 directly rather than through the memory bridge 205, and other devices can communicate with the system memory 114 via the memory bridge 205 and the processor(s) 112. In other embodiments, the parallel processing subsystem 212 can be connected to the I/O bridge 207 or directly to the processor(s) 112, rather than to the memory bridge 205. In still other embodiments, the I/O bridge 207 and the memory bridge 205 can be integrated into a single chip instead of existing as one or more discrete devices. In certain embodiments, one or more components shown in FIG. 2 may not be present. For example, the switch 216 could be eliminated, and the network adapter 218 and add in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

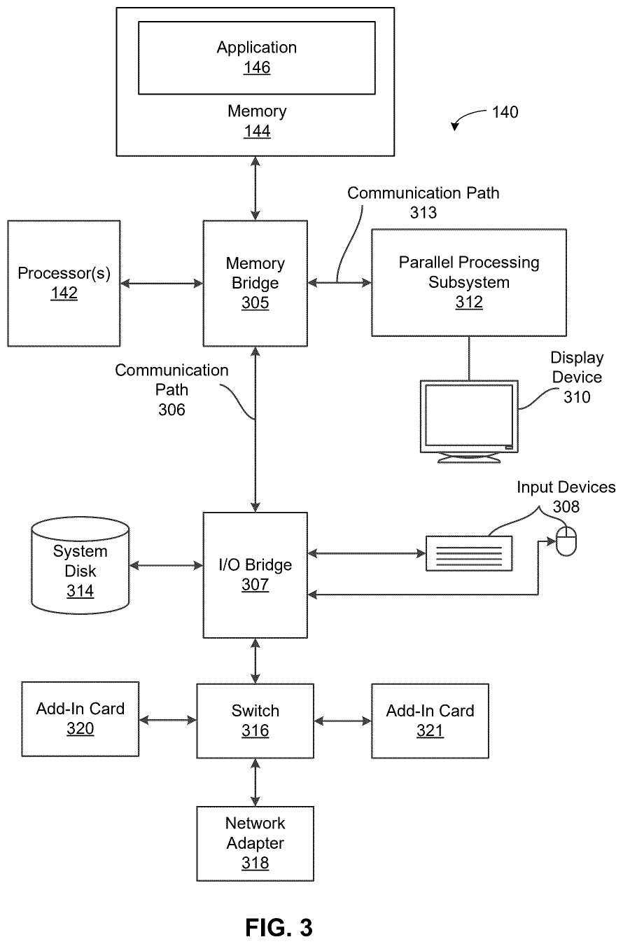

FIG. 3 is a more detailed illustration of the computing system 140 of FIG. 1, according to various embodiments. In some embodiments, the computing system 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 140 is a server machine operating in a data center or a cloud computing environment that provides scalable computing resources as a service over a network.

In some embodiments, the computing system 140 includes, without limitation, the processor(s) 142 and the memory (ies) 144 coupled to a parallel processing subsystem 312 via a memory bridge 305 and a communication path 306. Memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing system 140 can be a server machine in a cloud computing environment. In such embodiments, the computing system 140 can not include the input devices 308, but can receive equivalent input information by receiving commands (e.g., responsive to one or more inputs from a remote computing device) in the form of messages transmitted over a network and received via a network adapter 318. In some embodiments, the switch 316 is configured to provide connections between I/O bridge 307 and other components of the computing system 140, such as a network adapter 318 and various add in cards 320 and 321.

In some embodiments, the I/O bridge 307 is coupled to a system disk 314 that may be configured to store content and applications and data for use by the processor(s) 312 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 307 as well.

In some embodiments, the memory bridge 305 may be a Northbridge chip, and the I/O bridge 307 may be a Southbridge chip. In addition, the communication paths 306 and 313, as well as other communication paths within the computing system 140, can be implemented using any technically suitable protocols, including, without limitation, AGP (Accelerated Graphics Port), HyperTransport, or any other bus or point to point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations.

The system memory 144 includes at least one device driver configured to manage the processing operations of the one or more PPUs within the parallel processing subsystem 312. In addition, the system memory 144 includes the application 146, discussed in greater detail in conjunction with FIGS. 5 and 9. Although described herein primarily with respect to the application 146, techniques disclosed herein can also be implemented, either entirely or in part, in other software and/or hardware, such as in the parallel processing subsystem 312.

In some embodiments, the parallel processing subsystem 312 can be integrated with one or more of the other elements of FIG. 3 to form a single system. For example, the parallel processing subsystem 312 can be integrated with the processor(s) 142 and other connection circuitry on a single chip to form a system on a chip (SoC).

In some embodiments, the processor(s) 142 includes the primary processor of the computing system 140, controlling and coordinating operations of other system components. In some embodiments, the processor(s) 142 issues commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 312, and the number of parallel processing subsystems 312, can be modified as desired. For example, in some embodiments, the system memory 144 could be connected to the processor(s) 142 directly rather than through the memory bridge 305, and other devices can communicate with system memory 144 via the memory bridge 305 and the processor(s) 142. In other embodiments, the parallel processing subsystem 312 can be connected to the I/O bridge 307 or directly to the processor(s) 142, rather than to the memory bridge 305. In still other embodiments, I/O bridge 307 and the memory bridge 305 can be integrated into a single chip instead of existing as one or more discrete devices. In certain embodiments, one or more components shown in FIG. 3 may not be present. For example, the switch 316 could be eliminated, and the network adapter 318 and add the in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Interpretable Classifiers via Multi-Level Concept Prototypes

FIG. 4 is a more detailed illustration of the model trainer 116 of FIG. 1, according to various embodiments. As shown, the model trainer 116 includes the classifier neural network 150, a concept segmentation module 410, a concept prototype extract module 420, an image multi-concept prototype (MCP) distribution module 430, a class MCP distribution module 440, and a loss computation module 450. Illustratively, the interpretable classifier 150 includes four layers, each of which outputs a feature map 412i (referred to herein collectively as feature maps 412 and individually as a feature map 412) when an image (not shown) is input into the classifier 150. More generally, in some embodiments, an interpretable classifier that is an artificial neural network can include any number of layers. Although described herein primarily with respect to interpretable classifiers that process images as a reference example, in some embodiments, interpretable classifiers can be trained according to techniques disclosed herein to process any suitable data.

The concept segmentation module 410 splits the feature maps 412 output by layers of the interpretable classifier 150 into a number of concept segments 414, each of which is a fixed length. For example, the feature maps 412 could correspond to different channels that are each represented by a vector, and the concept segmentation module 410 can split the feature maps 412 evenly into a number of concept segments 414, each of which is represented by a shorter vector.

For each of one or more training epochs, shown using ghosted arrows, the model trainer 116 re-computes an MCP distribution for each of a number of classes that the interpretable classifier 150 is being trained to classify images as. First, the concept prototype extract module 420 performs a principal component analysis (PCA) technique to extract concept prototypes 424 from the concept segments 414. The PCA technique emphasizes pixel importance, enhancing the extraction and representation of concept prototypes.

The image MCP distribution module 430 generates, for each training image in a set of training images, a corresponding MCP distribution (e.g., MCP distribution 436) using the concept prototypes 424 and the concept segments 414 generated from the training image. In some embodiments, the MCP distribution module 430 can scan the training image using activations of different layers of the interpretable classifier 150 to determine how much activation corresponds to each concept prototype 424. The MCP distribution module 430 can then generate an MCP distribution that indicates, for each concept prototype, the corresponding activation of one of the layers of the interpretable classifier 150 when the training image is given as input to the interpretable classifier 150. The MCP class distribution module 440 averages the corresponding MCP distributions generated for the training images associated with each class (e.g., MCP distribution 442) to generate an MCP distribution for the class (e.g., class MCP distribution 444). The class that each training image is associated with is provided as input to the model trainer 116 (i.e., the training is supervised).

More formally, for a single input data (i.e. B=1), each concept segment Sui in the I-th layer of the interpretable classifier 150 includes Hₗ·Wₗ feature vectors of length C′. When it comes to the entire dataset of N data samples, there will be in total N·Hₗ·Wₗ feature vectors for Sui, and every feature vector serves as an instance of the corresponding semantic behind the concept segment. In order to better outline such semantic globally behind Sur, the principal direction of all these feature vectors (i.e. analogous to the common ground among the feature vectors) can be identified by using the weighted PCA technique, in which each feature vector is weighted according to its L2-norm to account for the degree of importance.

The resultant principal direction (i.e., the eigenvector corresponding to the largest eigenvalue of the covariance matrix built upon N·Hₗ·Wₗ feature vectors of length C′ for Sui) is referred to herein as the concept prototype. Note that the concept prototype is globally defined and shared within the entire dataset, while the concept segments in turn act more likely as the sample-wise or batch-wise instantiation of the corresponding semantic. Hence, the prototype response of a concept segment Sui (which is based on the input of a single sample or a batch of samples) can further be computed with respect to the corresponding concept prototype Pui, according to the following procedure: firstly, the response map which records the cosine similarities of Pui at each position on Sui is computed, and then the max-pooling is applied on the response map to obtain the prototype response. Such a prototype response stands for the degree of agreement between concept segments and the concept prototype, hence signifying how likely the input sample(s) contributing to the concept segments would own the particular semantic of the target concept prototype. It should be noted that, while the numerical range of original prototype response is [−1.0,1.0], in some embodiments, the model trainer 116 can map the prototype response to the range of [0.0,1.0] for better usage in later computations.

In some embodiments, the extraction of concept prototypes is thoroughly applied on all the concept segments from all the layers of the interpretable classifier 150, leading to multi-level concept prototypes for the different layers. By contrast, conventional techniques can only provide single level explanation, typically extracted from the last layer of a neural network.

Returning to FIG. 4, during an epoch of training, the model trainer 116 can process batches of images at a time, shown using solid arrows in FIG. 4. For each batch of training images, a Centered Kernel Alignment (CKA) loss module in the loss computation module 450 computes a CKA loss that disentangles features in different concept segments 414, thereby forcing concept prototypes to be different from each other. Use of the CKA facilitates the autonomous learning of meaningful concept prototypes within the concept segments 414. In addition, a Class-aware Concept Distribution (CCD) loss module 470 computes a CCD loss that enhances the differences between MCP distributions for images associated with different classes while minimizing the differences between MCP distributions for images associated with the same class. The CCD loss is used to refine class distinction based on learned concept distributions and minimizes intra-class variation in such distributions.

The loss computation module 450 computes a loss by adding together the CKA loss and the CCD loss. Then, the model trainer 116 updates parameters of the interpretable classifier 150 using the computed loss for the batch of images.

More formally, given a feature map Fₜ ∈ [symbol] ^{B×C}^{ₗ}^{×H}^{ₗ}^{×W}^{ₗ} of dimension (width Hₗ× height Wₗ× channels Cₗ) and batch size B obtained from the l-th layer of the interpretable classifier 150, as the general architecture design of deep neural networks by nature extracts different characteristics of input data into features placed along channels (i.e., each channel stands for a certain data characteristic), the goal is to partition the feature map Fₗ along the channel dimension into several distinct segments, where each segment of size [symbol] ^{B×C′}^{ₗ}^{×H}^{ₗ}^{×W}^{ₗ} groups C_{l′} channels to form a more semantically meaningful component (representing a specific combination of data characteristics), referred to herein as a “concept.” The concepts serve as a bridge/proxy to provide more interpretable explanations for the input image samples towards their corresponding categories/classes. Moreover, the concepts ideally should be diverse and discriminative from each other in order to describe the data from different aspects, forming a more concise but representative basis of interpretation. In some embodiments, the CKA loss [symbol] ^{CKA}, which leverages the CKA metric to measure the similarity among segments, can be minimized to create distinct concepts (i.e., the concepts are learned to be dissimilar and independent from each other).

Basically, given two concept segments X and [symbol] , their CKA similarity CKA (X, [symbol] ) can be defined as:

$$CKA ( 𝒳 , 𝒴 ) = \frac{( 𝒳 , 𝒴 )}{\sqrt{( 𝒳 , 𝒴 )} \sqrt{( 𝒴𝒴 )}} , \qquad ( 1 )$$

where the operator [symbol] stands for the unbiased Hilbert-Schmidt independence criterion, with [symbol] (X, [symbol] ) being formulated as:

$$\frac{1}{B ( B - 3 )} ( tr ( \tilde{K} \tilde{L} ) + \frac{{1}^{T} \tilde{K} {11}^{T} \tilde{L} 1}{( B - 1 ) ( B - 2 )} - \frac{2}{B - 2} {1}^{T} \tilde{K} \tilde{L} 1 ) , \qquad ( 2 )$$

where \tilde{K} and \tilde{L} are stemmed from the kernel matrices of X and [symbol] , respectively, with \tilde{K}_{i,j}=(1− [symbol] ᵢ₌ⱼ)Kᵢⱼ and \tilde{L}_{i,j}=(1− [symbol] ᵢ₌ⱼ)Lᵢⱼ. Note that the variable B stands for the number of samples involved into the computation of [symbol] , which can be the batch size during training. Based on the CKA similarities between segments from Fₗ, the CKA loss [symbol] ^{CKA} of the l-th layer is defined as:

$${ℒ}^{CKA} ( {S}_{l} ) = \frac{2}{{M}_{l} ( {M}_{l} - 1 )} {\sum }_{i = 1}^{{M}_{l}} {\sum }_{j = i}^{{M}_{l}} CKA ( {S}_{l , i} , {S}_{l , i} ) , \qquad ( 3 )$$

where S_{l,i} and Mₗ=Cₗ/C′ₗ denotes the i-th concept segment and the total number of segments of the l-th layer, respectively.

Turning to the CCD loss, from the cognitive perspective, image samples belonging to the same class ideally should have a similar combination of concepts. The CCD loss encourages the image samples of the same class to have similar distributions of concept prototypes (i.e., the distribution upon the prototype responses with respect to all the multi-level concept prototypes) while enlarging the distribution distance across different classes. In other words, the CCD loss helps to realize the classification via leveraging the MCP distribution, while forsaking the typical fully-connected-layer-based classifier and providing better interpretability.

Let the MCP distribution of an input sample/image xᵢ be denoted as Di and the class label of xᵢ as y (xᵢ), the class-specific centroid MCP distribution D^{c} can be computed by averaging Dᵢ of all the samples xᵢ belonging to the same class c=y (xᵢ). Then, the CCD loss is defined as:

$${ℒ}^{CCD} ( {x}_{i} ) = ( {D}_{i} , {D}^{c = y ( {x}_{i} )} ) + {\sum }_{{c}^{′} \neq y ( {x}_{i} )} max ( m - ( {D}_{i} , {D}^{{c}^{′}} ) , 0 ) , \qquad ( 4 )$$

where [symbol] stands for the Jensen-Shannon divergence, while m is the margin such that [symbol] (Dᵢ, D^{c′}) contributes to the loss only if it is smaller than m, which helps to avoid a collapsed solution.

The overall objective function [symbol] to train the interpretable classifier 150 is the combination of both CKA and CCD losses:

$$ℒ = {\sum }_{l = 1}^{L} {ℒ}^{CKA} ( {S}_{l} ) + {\sum }_{{x}_{i} ∈ X} {ℒ}^{CCD} ( {x}_{i} ) , \qquad ( 5 )$$

where L denotes the number of layers in the interpretable classifier 150 and X denotes the training dataset. In some embodiments, all the concept prototypes and all the class-specific centroid MCP distributions are updated after every epoch on the training set to reflect the newest features learned by the interpretable classifier 150.

FIG. 5 is a more detailed illustration of the application 146 of FIG. 1, according to various embodiments. As shown, the application 146 includes a distribution generator module 502 (also referred to herein as “distribution generator 502”) and a comparison module 504. Once trained, the interpretable classifier 150 can be used to process an image to generate a classification of the image, as well as reveal details about how the interpretable classifier 150 generated the classification. Illustratively, the distribution generator 502 processes an input image 506 using the interpretable classifier 150 to generate an MCP distribution 508. In some embodiments, the MCP distribution 508 can be generated in a similar manner as the MCP distributions (e.g., MCP distribution 436) described above in conjunction with FIG. 4.

The comparison module 504 compares the MCP distribution 508 generated for the input image 506 with MCP distributions 510, 512, and 514 for a number of classes, which can be obtained during training of the interpretable classifier 150 by averaging MCP distributions for training images associated with each class as described above in conjunction with FIG. 4, to determine a most similar class. Any technically feasible measure of distance can be used in some embodiments to determine the most similar class. For example, in some embodiments, the comparison module 504 can compute the Jensen-Shannon distance between the MCP distribution 508 for the input image 506 and each of the MCP distributions 510, 512, and 514 for the classes. In such a case, the comparison module 504 can select a class, shown as the class 510, that is associated with a smallest Jensen-Shannon distance. The application 146 can then output or otherwise use the most similar class 510 as a classification for the image 506.

It should be noted that a fully connected layer (not shown) at the end of the interpretable classifier 150 is not required to perform classification. Instead, classification of an input sample xᵢ (e.g., the image 506) is performed simply via searching for the closest class-specific centroid MCP distribution to Di:

$$\tilde{y} ( {x}_{i} ) = arg {min}_{c} ( {D}_{i} , {D}^{c} ) . \qquad ( 6 )$$

That is, classification can be achieved by comparing the MCP distribution of an image against class-specific centroid MCP distributions, identifying the most similar class without relying on conventional fully connected layers. Doing so not only offers in-depth, multi-level explanations across the entire interpretable classifier 150 but also allows for seamless integration with multiple convolution-based architectures without additional modules or trainable parameters, maintaining high classification accuracy.

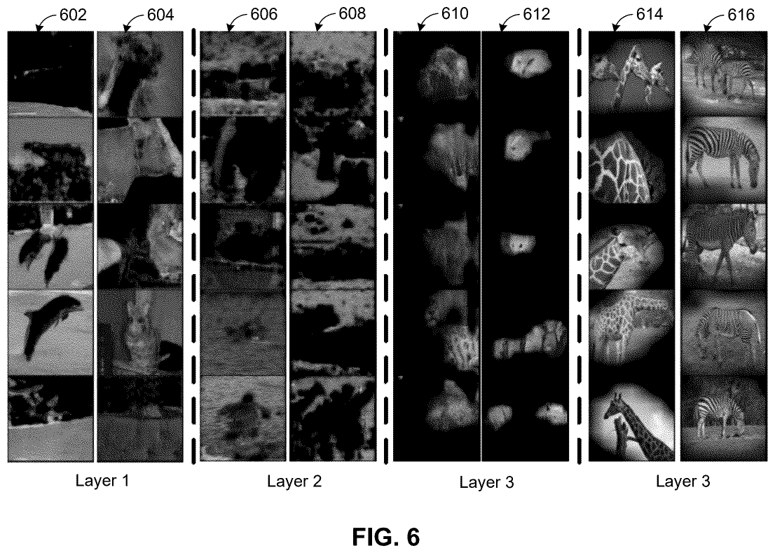

FIG. 6 illustrates exemplar concept prototypes for different layers of an interpretable classifier, according to various embodiments. As shown, the model trainer 116 has generated concept prototypes 602 and 604 for a first layer of an interpretable classifier (not shown), concept prototypes 606 and 608 for a second layer of the interpretable classifier, concept prototypes 610 and 612 for a third layer of the interpretable classifier, and concept prototypes 614 and 616 for a fourth layer of the interpretable classifier. The concept prototypes 602, 604, 606, 608, 610, 612, 614, and 616 represent different scale meanings in the different layers. Illustratively, the concept prototypes 602 and 604 for the first layer represent colors, whereas the concept prototypes for the deeper layers, such as the concept prototypes 614 and 616 for the fourth layer, represent objects such as stripes and dots. Images showing the highest activation values for the concept prototypes 602, 604, 606, 608, 610, 612, 614, and 616, when feature map activations are mapped back to original images to show which regions of those images activate the highest values, were extracted from training images to show a user what the concept prototypes 602, 604, 606, 608, 610, 612, 614, and 616 look like.

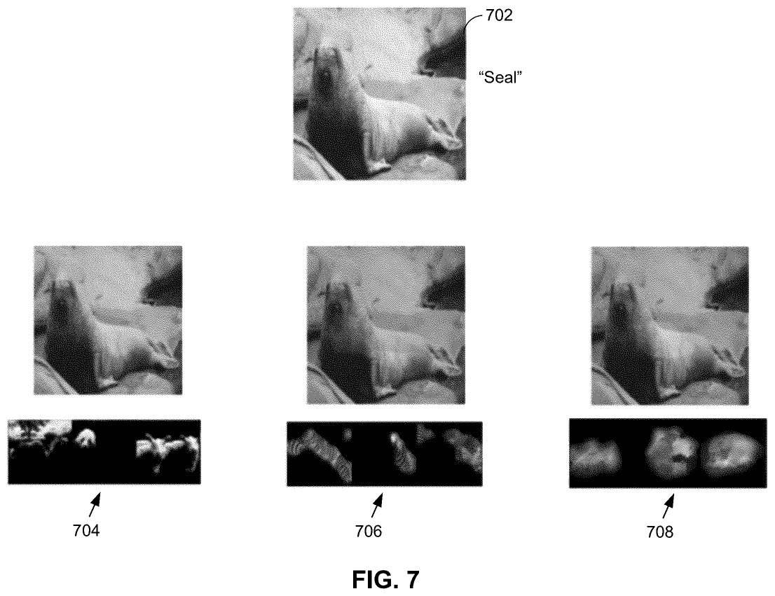

FIG. 7 illustrates how exemplar multi-level concept prototypes can be used to explain an erroneous classification, according to various embodiments. As shown, the interpretable classifier 150 has classified an image 702 of a walrus as a “Seal.” An MCP distribution (not shown) for the image 702 can be used to understand how the interpretable classifier 150 determined the image 702 to be a “Seal.” Illustratively, the MCP distribution indicates that one layer of the interpretable classifier 150 was most activated for a white color concept prototype 704. The MCP distribution also indicates that another layer of the interpretable classifier 150 was most activated for a striped concept prototype 706. In addition, the MCP distribution indicates that another layer of the interpretable classifier 150 was most activated for a fur concept prototype 708.

FIG. 8 is a flow diagram of method steps for training an interpretable classifier, according to various embodiments. Although the method steps are described in conjunction with FIGS. 1-5, persons skilled in the art will understand that any system configured to perform the method steps, in any order, falls within the scope of the present invention.

As shown, a method 800 begins at step 802, where the model trainer 116 receives a set of training images and associated classifications. Any training images that have been labeled with classifications for an interpretable classifier to learn can be used in some embodiments.

At step 804, the model trainer 116 processes the training images using the interpretable classifier 150 to generate feature maps. Given a training image as input, individual layers of the interpretable classifier 150 output features maps, which can include features for a number of channels.

At step 806, the model trainer 116 splits the feature maps into concept segments. In some embodiments, the model trainer 116 splits each feature map, which can be represented by a vector, evenly into a number of concept segments, which can be represented by shorter vectors.

At step 808, the model trainer 116 extracts global concept prototypes from the concept segments. In some embodiments, the model trainer 116 can extract the global concept prototypes by performing PCA analysis on corresponding concept segments that are generated for each of the training images, as described above in conjunction with FIG. 4.

At step 810, the model trainer 116 generates MCP distributions for the training images. In some embodiments, for each training image, the model trainer 116 can generate an MCP distribution by scanning the training image using activations of different layers of the interpretable classifier 150 to determine how much activation corresponds to each concept prototype determined at step 808. The MCP distribution indicates, for each concept prototype, the corresponding activation of one of the layers of the interpretable classifier 150 when the training image is given as input to the interpretable classifier 150.

At step 812, the model trainer 116 generates MCP class distributions by averaging the MCP distributions for training images associated with the same class.

At step 814, the model trainer 116 generates MCP distributions for images in a batch of images. Step 814 is similar to step 810, described above, except MCP distributions are generated for the images in the batch.

After generating the MCP distributions for the images in the batch at step 814, and after MCP class distributions have been generated at step 812, the method 800 continues to step 816, where the model trainer 116 calculates a loss that includes a CKA loss that disentangles features in different concept segments and a CCD loss based on the MCP distributions for the images in the batch and the class MCP distributions. In some embodiments, the model trainer 116 can calculate the CKA loss and the CCD loss according to equations (3) and (4), respectively, described above in conjunction with FIG. 4. In such cases, the overall loss can be computed as a sum of the CKA loss and the CDD loss, according to equation (5).

At step 818, the model trainer 116 updates parameters of the interpretable classifier 150 based on the loss calculated at step 816. In some embodiments, the model trainer 116 can apply backpropagation with gradient descent, or a variation thereof, to update the parameters of the interpretable classifier 150.

At step 820, if there are more batches to process, then the method continues to step 822, where the model trainer 116 selects another batch of images. The method 800 then returns to step 814, where the model trainer 116 generates MCP distributions for images in the selected batch.

On the other hand, if there are no more batches to process, then the method 800 continues to step 824. At step 824, if the model trainer 116 determines to train for more epochs, then the method 800 returns to step 804, where a new epoch begins with the model trainer 116 again processing the training images using the interpretable classifier 150 to generate feature maps. On the other hand, if the model trainer 116 determines to stop training, then the method 800 ends.

FIG. 9 is a flow diagram of method steps for performing classification using a trained interpretable classifier, according to various embodiments. Although the method steps are described in conjunction with FIGS. 1-5, persons skilled in the art will understand that any system configured to perform the method steps, in any order, falls within the scope of the present invention.

As shown, a method 900 begins at step 902, where the application 146 receives an image for classification. For example, the image could be a standalone image or a frame of a video.

At step 904, the application 146 processes the image using the interpretable classifier 150. Given the image as input, the interpretable classifier 150 outputs a classification for the image, and individual layers of the interpretable classifier 150 output features.

At step 906, the application 146 generates an MCP distribution from features output by layers of the interpretable classifier 150. Step 906 is similar to step 814, described above in conjunction with FIG. 8, except an MCP distribution is generated for the image received at step 902 rather than for a training image.

At step 908, the application 146 compares the MCP distribution generated at step 906 to MCP distributions of features for different classes to determine a most similar class. Any technically feasible measure of similarity can be used to determine the most similar class in some embodiments. For example, in some embodiments, a Jenson-Shannon distance can be computed between the generated MCP distribution and each of the MCP distributions for the different classes, and a class whose MCP distribution has the smallest Jenson-Shannon distance to the generated MCP distribution can be selected as the most similar class. The application 146 can then output or otherwise use the most similar class as a classification for the image received at step 902.

In sum, techniques are disclosed for training and using interpretable classifier neural networks. In some embodiments, a model trainer processes a number of training images using an interpretable classifier. Given such training images, layers of the interpretable classifier output feature maps that the model trainer splits into concept segments. For each of one or more training epochs, the model trainer re-computes an MCP distribution for each of a number of classes that the interpretable classifier is being trained to classify images as. The model trainer re-computes the MCP distributions by performing a PCA technique to extract concept prototypes from the concept segments, described above. Then, the model trainer generates, for each training image, a corresponding MCP distribution using the concept prototypes and the concept segments generated from the training image. The model trainer averages the corresponding MCP distributions generated for the training images associated with each class to generate an MCP distribution for the class. In addition, for each of any number of batches of training images, the model trainer computes a loss that includes (1) a CKA loss term that disentangles features in different concept segments, and (2) a CCD loss term that enhances the differences between MCP distributions for images associated with different classes while minimizing the differences between MCP distributions for images associated with the same class. The model trainer updates parameters of the interpretable classifier using the computed loss.

Once trained, the interpretable classifier can be used to process an image to generate a classification of the image and reveal details about how the interpretable classifier generated the classification. In some embodiments, an application can process the image using the interpretable classifier, and different layers of the interpretable classifier output respective features. The application generates an MCP distribution from the features, and the application compares the generated MCP distribution with MCP distributions of features for a number of classes to determine a most similar class, which the image is classified as.

At least one technical advantage of the disclosed techniques relative to the prior art is that concept prototypes, which are learned for each layer of a classifier neural network, can be used to reveal or explain how the different layers of the classifier neural network process data at different levels of abstraction. In addition, the concept prototypes are learned automatically during training of the classifier neural network, without requiring manual guidance, modification of the classifier neural network architecture, or post-hoc analysis after the classifier neural network is trained. These technical advantages represent one or more technological improvements over prior art approaches.
1. In some embodiments, a computer-implemented method for classifying data comprises processing data via a trained machine learning model that includes a plurality of layers, wherein each layer generates one or more corresponding features, generating a first distribution of features based on the one or more corresponding features generated by each layer included in the plurality of layers, and determining a first class for the data based on a comparison of the first distribution of features with one or more predefined distributions of features that are associated with one or more classes.
2. The computer-implemented method of clause 1, wherein generating the first distribution of features comprises scanning the data to determine an amount of activation of each layer included in the plurality of layers that corresponds to each concept prototype included in a plurality of concept prototypes.
3. The computer-implemented method of clauses 1 or 2, further comprising performing one or more operations to generate the plurality of concept prototypes when training a first machine learning model to generate the trained machine learning model.
4. The computer-implemented method of any of clauses 1-3, wherein the plurality of concept prototypes includes at least one concept prototype for each layer included in the plurality of layers.
5. The computer-implemented method of any of clauses 1-4, further comprising generating the plurality of concept prototypes by performing one or more principal component analysis operations on a plurality of segments of one or more feature maps generated by the plurality of layers.
6. The computer-implemented method of any of clauses 1-5, further comprising performing one or more operations to train an untrained machine learning model to generate the trained machine learning model using a loss that is computed based on a plurality of segments of one or more feature maps generated by the untrained machine learning model.
7. The computer-implemented method of any of clauses 1-6, further comprising performing one or more operations to train an untrained machine learning model to generate the trained machine learning model using a loss that increases distances between distributions of features associated with different classes and decreases distances between distributions of features associated with a same class.
8. The computer-implemented method of any of clauses 1-7, further comprising generating the one or more predefined distributions of features when training an untrained machine learning model in order to produce the trained machine learning model.
9. The computer-implemented method of any of clauses 1-8, wherein the trained machine learning model comprises a classifier neural network.
10. The computer-implemented method of any of clauses 1-9, wherein the data comprises image data.
11. In some embodiments, one or more non-transitory computer-readable media store instructions that, when executed by at least one processor, cause the at least one processor to perform the steps of processing data via a trained machine learning model that includes a plurality of layers, wherein each layer generates one or more corresponding features, generating a first distribution of features based on the one or more corresponding features generated by each layer included in the plurality of layers, and determining a first class for the data based on a comparison of the first distribution of features with one or more predefined distributions of features that are associated with one or more classes.
12. The one or more non-transitory computer-readable media of clause 11, wherein generating the first distribution of features comprises scanning the data to determine an amount of activation of each layer included in the plurality of layers that corresponds to each concept prototype included in a plurality of concept prototypes.
13. The one or more non-transitory computer-readable media of clauses 11 or 12, wherein the instructions, when executed by the at least one processor, further cause the at least one processor to perform the step of performing one or more operations to generate the plurality of concept prototypes when training a first machine learning model to generate the trained machine learning model.
14. The one or more non-transitory computer-readable media of any of clauses 11-13, wherein the plurality of concept prototypes includes at least one concept prototype for each layer included in the plurality of layers.
15. The one or more non-transitory computer-readable media of any of clauses 11-14, wherein the instructions, when executed by the at least one processor, further cause the at least one processor to perform the step of generating the plurality of concept prototypes by performing one or more principal component analysis operations on a plurality of segments of one or more feature maps generated by the plurality of layers.
16. The one or more non-transitory computer-readable media of any of clauses 11-15, wherein the instructions, when executed by the at least one processor, further cause the at least one processor to perform the step of performing one or more operations to train an untrained machine learning model to generate the trained machine learning model using a first loss that is computed based on a plurality of segments of one or more feature maps generated by the untrained machine learning model and a second loss that increases distances between distributions of features associated with different classes and decreases distances between distributions of features associated with a same class.
17. The one or more non-transitory computer-readable media of any of clauses 11-16, wherein the instructions, when executed by the at least one processor, further cause the at least one processor to perform the step of generating the one or more predefined distributions of features when training an untrained machine learning model in order to produce the trained machine learning model.

18. The one or more non-transitory computer-readable media of any of clauses 11-17, wherein determining the first class comprises computing a respective distance between the first distribution of features and each predefined distribution included in the one or more predefined distributions, and selecting the first class that is associated with a smallest distance included in the respective distances.

19. The one or more non-transitory computer-readable media of any of clauses 11-18, wherein the respective distances are Jensen-Shannon distances.

20. In some embodiments, a system comprises one or more memories storing instructions, and one or more processors that are coupled to the one or more memories and, when executing the instructions, are configured to process data via a trained machine learning model that includes a plurality of layers, wherein each layer generates one or more corresponding features, generate a first distribution of features based on the one or more corresponding features generated by each layer included in the plurality of layers, and determine a first class for the data based on a comparison of the first distribution of features with one or more predefined distributions of features that are associated with one or more classes.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for classifying data, the method comprising:
processing data via a trained machine learning model that includes a plurality of layers, wherein each layer generates one or more corresponding features;
generating a first distribution of features based on the one or more corresponding features generated by each layer included in the plurality of layers; and
determining a first class for the data based on a comparison of the first distribution of features with one or more predefined distributions of features that are associated with one or more classes.

2. The computer-implemented method of claim 1, wherein generating the first distribution of features comprises scanning the data to determine an amount of activation of each layer included in the plurality of layers that corresponds to each concept prototype included in a plurality of concept prototypes.

3. The computer-implemented method of claim 2, further comprising performing one or more operations to generate the plurality of concept prototypes when training a first machine learning model to generate the trained machine learning model.

4. The computer-implemented method of claim 2, wherein the plurality of concept prototypes includes at least one concept prototype for each layer included in the plurality of layers.

5. The computer-implemented method of claim 2, further comprising generating the plurality of concept prototypes by performing one or more principal component analysis operations on a plurality of segments of one or more feature maps generated by the plurality of layers.

6. The computer-implemented method of claim 1, further comprising performing one or more operations to train an untrained machine learning model to generate the trained machine learning model using a loss that is computed based on a plurality of segments of one or more feature maps generated by the untrained machine learning model.

7. The computer-implemented method of claim 1, further comprising performing one or more operations to train an untrained machine learning model to generate the trained machine learning model using a loss that increases distances between distributions of features associated with different classes and decreases distances between distributions of features associated with a same class.

8. The computer-implemented method of claim 1, further comprising generating the one or more predefined distributions of features when training an untrained machine learning model in order to produce the trained machine learning model.

9. The computer-implemented method of claim 1, wherein the trained machine learning model comprises a classifier neural network.

10. The computer-implemented method of claim 1, wherein the data comprises image data.

11. One or more non-transitory computer-readable media storing instructions that, when executed by at least one processor, cause the at least one processor to perform the steps of:
processing data via a trained machine learning model that includes a plurality of layers, wherein each layer generates one or more corresponding features;
generating a first distribution of features based on the one or more corresponding features generated by each layer included in the plurality of layers; and
determining a first class for the data based on a comparison of the first distribution of features with one or more predefined distributions of features that are associated with one or more classes.

12. The one or more non-transitory computer-readable media of claim 11, wherein generating the first distribution of features comprises scanning the data to determine an amount of activation of each layer included in the plurality of layers that corresponds to each concept prototype included in a plurality of concept prototypes.

13. The one or more non-transitory computer-readable media of claim 12, wherein the instructions, when executed by the at least one processor, further cause the at least one processor to perform the step of performing one or more operations to generate the plurality of concept prototypes when training a first machine learning model to generate the trained machine learning model.

14. The one or more non-transitory computer-readable media of claim 12, wherein the plurality of concept prototypes includes at least one concept prototype for each layer included in the plurality of layers.

15. The one or more non-transitory computer-readable media of claim 12, wherein the instructions, when executed by the at least one processor, further cause the at least one processor to perform the step of generating the plurality of concept prototypes by performing one or more principal component analysis operations on a plurality of segments of one or more feature maps generated by the plurality of layers.

16. The one or more non-transitory computer-readable media of claim 11, wherein the instructions, when executed by the at least one processor, further cause the at least one processor to perform the step of performing one or more operations to train an untrained machine learning model to generate the trained machine learning model using a first loss that is computed based on a plurality of segments of one or more feature maps generated by the untrained machine learning model and a second loss that increases distances between distributions of features associated with different classes and decreases distances between distributions of features associated with a same class.

17. The one or more non-transitory computer-readable media of claim 11, wherein the instructions, when executed by the at least one processor, further cause the at least one processor to perform the step of generating the one or more predefined distributions of features when training an untrained machine learning model in order to produce the trained machine learning model.

18. The one or more non-transitory computer-readable media of claim 11, wherein determining the first class comprises:
computing a respective distance between the first distribution of features and each predefined distribution included in the one or more predefined distributions; and
selecting the first class that is associated with a smallest distance included in the respective distances.

19. The one or more non-transitory computer-readable media of claim 18, wherein the respective distances are Jensen-Shannon distances.

20. A system, comprising:
one or more memories storing instructions; and
one or more processors that are coupled to the one or more memories and, when executing the instructions, are configured to:
process data via a trained machine learning model that includes a plurality of layers, wherein each layer generates one or more corresponding features,
generate a first distribution of features based on the one or more corresponding features generated by each layer included in the plurality of layers, and
determine a first class for the data based on a comparison of the first distribution of features with one or more predefined distributions of features that are associated with one or more classes.
